(19) United States
(12) Patent Application Publication
(10) Pub. No.: US 2024/0254036 A1
(43) Pub. Date: Aug. 1, 2024

(54) SUBSTRATE FOR LIQUID DROPLETS

(71) Applicant: LPKF LASER & ELECTRONICS AG, Garbsen (DE)

(72) Inventors: Robin Krüger, Hannover (DE); Malte Schulz-Ruhtenberg, Wunstorf (DE); Oktavia Ostermann, Hannover (DE); Bernd Rösener, Porta Westfalica (DE)

(21) Appl. No.: 17/784,977

(22) PCT Filed: Dec. 16, 2020
(86) PCT No.: PCT/EP2020/086577

§ 371 Date: Apr. 15, 2024

(30) Foreign Application Priority Data
Dec. 17, 2019 (DE) 10 2019 219 913.5

(51) Int. Cl. C03C 17/30; C03C 15/00; C03C 23/00

(52) U.S. Cl. CPC C03C 17/30; C03C 15/00; C03C 23/0025; C03C 2217/76

(57) ABSTRACT

The invention provides a carrier in the form of a glass plate having recesses formed therein which extend through the full thickness of the carrier and whose opposing terminal cross-sections are open in the plane of the opposing surfaces of the glass plate. The recesses therefore form through-holes through the glass plate and have an inside diameter of 5 to 1000 μm.

The present invention relates to a glass carrier having a large number of recesses for liquid droplets and to a method for analysis with optical detection of liquid droplets arranged in the recesses. Further, the invention relates to methods for arranging liquid droplets in recesses of a glass with optional treatment of the liquid droplets by irradiation with excitation radiation or detection radiation and/or introduction and/or removal of components in a liquid. The recesses have a small inner volume and have the advantage of holding liquid droplets of small volumes, so that the position of the liquid droplets held in the recesses can be easily determined and the individual liquid droplets can be easily detected optically.

### STATE OF THE ART

Glass and plastic plates with V-shaped, cylindrical or angular blind holes are known as carriers for liquid droplets. For optical detection, the blind holes are irradiated either from the topside or the bottomside of the plate. The bottom side of the plate has a high optical transmissibility.

### OBJECT OF THE INVENTION

The invention has the object of providing an alternative carrier having recesses capable of receiving liquid droplets, and of providing an alternative method for optically detecting and/or introducing liquid into the recesses in this carrier.

### DESCRIPTION OF THE INVENTION

The invention achieves the object by the features of the claims and, in particular, provides a carrier in the form of a glass plate in which recesses are formed which extend through the entire thickness of the carrier and whose mutually opposite terminal cross sections are open in the plane of the mutually opposite surfaces of the glass plate. The recesses therefore form through-holes through the glass plate. The recesses have, for example, an inner diameter of from 5 to 1000 μm, e.g., from 10 μm or from 20 μm to 800 μm or to 500 μm or to 200 μm. The cross-section perpendicular to the longitudinal center axis of the recesses is generally preferably circular.

The inner diameter may be constant through the thickness of the glass plate or may taper from the terminal cross sections lying in the plane of the opposite surfaces of the glass plate to a smaller inner diameter spaced from the planes of the surfaces of the glass plate, e.g., spaced by from 10 to 50% of the thickness of the glass plate from one of the surfaces. Therein, the recesses may taper conically from the surfaces of the glass plate to a smaller inner diameter.

Alternatively, the recesses may taper in a V-shape such that their smaller inner diameter spans open one of the terminal cross-sectional openings in the plane of the surface of the glass plate and the larger inner diameter spans open the opposite terminal cross-sectional opening. Therein, the etching parameters and the type of glass are matched so that a recess is formed with a diameter that decreases starting from the first surface of the glass plate to a point between the surfaces of the glass plate and then increases again to the second surface.

The glass plate, which has recesses extending completely through its thickness, has the advantage that the inner walls of the recesses hold liquid droplets for detection, wherein the optical detection can pass through the liquid droplets without passing through any part of the glass plate. This is because the recesses, formed as through-holes in the glass plate, hold liquid droplets without any part of the glass plate spanning the cross-section of the recesses. The absence of a bottom closing off one side of the recesses allows the recesses to be radiated through, e.g., parallel or centrally along the longitudinal axis of the recesses or perpendicular to a surface of the glass plate, without optical interference by the glass plate.

The embodiment in which the inner diameter of the recesses tapers to a smaller inner diameter that is spaced from the surfaces of the glass plates has the advantage of locating a liquid droplet in the region of the smaller inner diameter, even if the volume of the liquid droplet is less than the volume of the recess between its terminal cross-sectional openings.

In general, the volume of a liquid droplet in the process can be larger than the volume of the recess between its terminal cross-sectional openings. This is because the liquid droplet is also held by its surface tension in its volume section that protrudes over the recess or a surface of the glass plate. Also in the embodiment in which at least one surface, preferably both surfaces, of the glass plate in which the cross-sectional openings of the recesses are located have a hydrophobic coating, the volume of the liquid droplet may be larger than the volume of the recess. A hydrophobic coating can be produced, for example, by hydrophobic silanization of the surfaces of the glass plate. This also prevents ‘spillover’ of the droplet into other recesses and thus cross-contamination between recesses.

For its use in the process, the glass plate has the advantage that the walls delimiting the recesses are hydrophilic, in particular made of uncoated glass. For a homogeneously hydrophilic wall of the recesses, it is preferred that the recesses are produced by an etching process in which each area of an original glass plate with continuous surfaces in which a recess is to be created is radiated through by a laser beam and subsequently this glass plate is etched. This is because in this process, the recesses are created along the light paths of the laser beams irradiated through the original glass plate without any mechanical impact by the etching bath.

Optionally, at least one surface of the glass plate or both surfaces of the glass plate in which the terminal cross-sectional openings of the recesses are arranged is provided with a coating which is preferably hydrophobic. The coating may consist of, for example, fluoroalkylsilane and/or alkylsilane bound to the glass surface. Therein, the silicon atom of the silane can be covalently bound to the glass surface with one, two or three bonds. The organic side groups of the silane may be saturated or unsaturated, for example containing at least one alkenyl radical or alkynyl radical. The side groups may be aliphatic (acyclic and/or cyclic), at least monounsaturated and/or aromatic. Preferably, the coating of the at least one surface of the glass plate is hydrophobic and can be obtained, e.g. by coating with hexamethyldisilazane, (3,3,3-trifluoropropyl)trichlorosilane, benzyldimethylchlorosilane, n-butyltrimethoxysilane, diethyldichlorosilane, di-n-octyldichlorosilane, (heptadecafluoro-1,1,2,2-tetra-hydrodecyl)trichlorosilane, hexadecafluorododec-11-en-1-yl-trichlorosilane, or a mixture of at least two of these. A hydrophobic coating on one surface of the glass plate has the advantage that liquid droplets that partially protrude over a recess spread less strongly to not at all over this adjacent surface. Optionally, the glass plate has a hydrophobic coating exclusively on the surface in which the through recesses have their larger terminal cross-sectional opening, e.g., in the case of conical recesses tapering from a larger terminal cross-sectional opening in the plane of one surface of the glass plate to a smaller terminal cross-sectional opening lying in the plane of the opposite surface of the glass plate.

Optionally, the glass plate may consist of glass that is impenetrable to a wavelength irradiated for detection or a wavelength absorbed for detection, which wavelength is e.g. emitted by the liquid droplet. Therein, the glass plate may consist of alkali silicate glass, borosilicate glass, fused silica, alkali borate glass, or aluminosilicate glass, and/or may be colored, e.g., by containing a color pigment, iron, and/or metal oxides.

Preferably, a second plate, which may be, for example, a glass plate, a plate of silicon or a plate of plastic, is arranged on one surface or on both opposite surfaces of the glass plate in which the recesses passing completely through its thickness are formed. The glass plate in which the recesses passing completely through its thickness are formed is also referred to herein as the first glass plate. The first glass plate, in particular its opposite surfaces between which the through recesses extend, may consist of glass, and respectively have no surface coating.

A second plate, e.g., a glass plate, silicon plate, or plastic plate, disposed on a surface of the first glass plate, may have second recesses that respectively cover terminal cross-sectional openings of the recesses of the first glass plate with a spacing. Preferably, second recesses of the second plate cover the terminal cross-sectional openings at a radial distance from the edge of the terminal cross-sections in relation to recesses of the first glass plate and at an axial distance from the plane of the terminal cross-sections, and respectively from the plane of the surface of the first glass plate in relation to recesses of the first glass plate. The radial distance of the second recesses from the edge of the terminal cross sections may be, for example, 5 to 500 μm. The axial distance of the second recesses from the plane of the terminal cross sections may be, for example, 5 to 500 μm. Second recesses may be produced by laser irradiation of the areas of a second original plate, in particular a second original glass plate, in the areas where second recesses are to be produced, and subsequent etching.

Generally, second recesses and/or the surface of the second plate adjacent to the first glass plate may have a coating that is preferably hydrophobic, e.g. coated with an alkyl silane. Alternatively, the second plate may consist of hydrophobic plastic.

Second recesses of a second plate may be formed as through-holes having a larger diameter in the plane of the surface of the second glass plate facing the first glass plate than the diameter of the terminal cross-sections of the recesses of the first glass plate. Optionally, a third plate, which may be a glass plate, a plate of silicon, or a plate of plastic, which is in contact with or bonded to the second plate opposite the first glass plate, may cover and close the through holes of the second plate.

Such second recesses of a second plate may have a shape which in each case covers only the terminal cross-section of a single recess of the first glass plate. Therein, the second plate can lie directly on the first glass plate and be bonded to it, optionally with glass frit arranged between them and hardened after softening, e.g. by means of glass frit bonding, by means of anodic bonding or fusion bonding.

Alternatively, second recesses of a second plate may be interconnected, for example, by the second plate being arranged with a spacing apart from the first glass plate. Such a spacing may be formed by the second plate having protruding portions that abut the first glass plate and act as spacers. Alternatively, such a spacing may be formed by arranging between the first glass plate and the second plate a spacer material, for example glass frit, applied as a paste to the first and/or to the second plate, which is preferably a glass plate, and subsequently heated to bond the plates, preferably both glass plates, together. In the embodiment in which a second plate is arranged with a spacing from and/or bonded to the first glass plate, the second surface of the second plate facing the first glass plate may be flat and closed, optionally with a hydrophobic coating.

The recesses in glass plates, in particular the recesses completely traversing the first glass plate, are created by spot-irradiating a laser beam of a wavelength to which the first glass plate is transparent onto the locations of the surface of a first glass plate at which a recess is to be created in each case, and etching the glass plate. For second recesses of the second plate, etching may optionally be terminated if the recesses extend only over a portion of the thickness of the second plate and therefore the second recesses have a bottom integrally formed in the second plate.

The surface of an original glass plate, and in the absence of a coating of etch resist also the second surface opposite to it, during etching at the locations where the laser was irradiated onto the glass plate and where the laser beam exited opposite to it, is ablated significantly faster than the neighboring areas. Therefore, the areas of the first surface and, if necessary, the second surface of the glass plate are ablated more slowly and uniformly at a distance from the points of point laser irradiation due to the absence of a coating, for example, of etch resist. Therefore, the opposing surfaces of the first glass plate, except for the recesses formed therein, are formed by surface portions each arranged in one plane from which the recesses extend into the glass volume of the first glass plate. The surface portions which are arranged in a combined plane and each forming a surface from which the recesses are excluded, are formed by the end faces of the walls lying between the recesses. In the presence of a coating, for example of etch resist, on one of the surfaces of the first glass plate, the recesses may also extend in a V-shape into the glass volume of the first glass plate starting from the opposite surface along the locations at which the laser beam had been spot-irradiated or radiated through. If none of the surfaces of the first glass plate are coated by etch resist, recesses can be formed that have an hourglass-shaped longitudinal cross-section through the thickness of the glass plate. Preferably, the recesses extend at an angle of, for example, 1° to 15° tapering conically from the surface of the first glass plate into the volume thereof.

The laser beam is preferably pulsed at each of the locations where it is incident on the first glass plate, e.g., with a wavelength of 1064 nm, preferably with pulse lengths of at maximum 100 ps or at maximum 50 ps, preferably at maximum 10 ps. Generally, the laser is arranged so that the laser beam does not strike the first glass plate between locations. Preferably, the laser beam is irradiated point-like and perpendicular to the surface of the first glass plate.

The etching is carried out, for example, with hydrofluoric acid, e.g. 1 to 48 wt. %, and/or sulfuric acid and/or hydrochloric acid and/or phosphoric acid and/or nitric acid, or potassium hydroxide solution, at e.g. up to 140° C.

For example, a glass plate that is original before etching may have a thickness of up to 800 μm, preferably 100 to 800 μm, e.g., 300 to 500 μm, and after etching may have a thickness that is smaller by 50 to 700 μm less, e.g. by up to 200 μm.

In the embodiment in which the recesses through the glass plate are V-shaped or tapered, the surface of the original glass plate in which the smaller cross-sectional opening of the recesses is disposed may be coated with etch resist. Optionally, after or before irradiation of the laser beam, etch resist may be applied over the entire surface of the first glass plate opposite to that surface onto which the laser beam was irradiated.

Optionally, generally the original first glass plate may be subjected to etching without a coating, e.g., without a mask and/or without etch resist, so that the process has the advantage of being performed without applying and without removing etch resist from a glass plate.

Generally, at least the first surface of the first glass plate remains without etch resist and without mask and is etched without etch resist.

Generally preferred, the first glass plate is one-pieced and the recesses extend exclusively through the first glass plate, preferably with the longitudinal center axis of each recess in perpendicular to the opposing two planar surfaces each of the first glass plate. Preferably, adjacent to the first glass plate there is no other component that encompasses single or at least two recesses in the plane of the surface of the first glass plate. For example, no component is disposed in the plane of the surface of the first glass plate between neighboring recesses and/or closer than the distance between neighboring recesses. Preferably, the surfaces of the first glass plate are free of components disposed thereon which are disposed between adjacent recesses and/or disposed closer than the spacing between neighboring recesses.

The use of the carrier in an analytical method has the advantage that each of the recesses of the first glass plate can receive a liquid droplet whose cross-section is not spanned by material of the first glass plate. Therefore, in analytical methods, a liquid droplet can be held exclusively by a recess whose terminal cross-sections are open, and respectively are in contact exclusively with the wall of the recess, the cross-section spanned by the wall not being covered by the first glass plate. Therefore, in an analytical method, a liquid droplet may be held exclusively by a recess whose cross-section is completely open. Therefore, for optical detection, the liquid droplet held in the recess can be transilluminated and emit radiation without radiation interacting with the glass plate in which the recess is formed.

In methods, e.g. analytical methods, liquid droplets, which may contain e.g. biological cells and active ingredients in culture medium, can be introduced into the recesses of the first glass plate by droplet-forming processes, e.g. printing processes, or by pumping through a hydrophobic conduit, e.g. a pipette tip. Therein, the carrier has the advantage, particularly in the case of hydrophobic coating of at least the surface to which the liquid is applied, that the liquid also moves into the recesses by capillary action. Optionally, droplets of liquid are introduced by accelerating the liquid with overpressure, in particular by means of a pressure surge, from a feed line onto the cross-sectional opening of a recess in the first glass plate in order to deposit individual droplets in a targeted manner onto terminal cross-sections of the recesses, preferably moving the feed line with a spacing from the first glass plate and/or positioning it at an equal or different distance from the first glass plate. Alternatively or additionally, liquid, in particular rinsing liquid, can be applied over the entire surface of a surface of the first glass plate, preferably with the step of removing liquid from the opposite surface, e.g. by applying negative pressure.

Alternatively or additionally, liquid may be introduced into recesses through channels formed in a surface of the first glass plate, wherein the liquid may be filled, for example, by means of a feed line directed to an area of a channel spaced from the recess. Preferably, such channels have a cross-section that is open only in the plane of the surface of the first glass plate and discharge into at least one recess. Channels are formed, for example, in a surface of the glass plate by etching.

A second plate disposed flush with or with a spacing from one surface or both surfaces of the first glass plate allows isolation from the environment of the liquid droplets held in the recesses of the first glass plate, as well as control of the atmosphere adjacent to the liquid droplets, e.g. for adjusting an atmosphere suitable for cell cultivation.

Generally, after etching, e.g., before or after applying a hydrophobic coating to at least one of the surfaces of the first glass plate, a liquid containing a constituent that is reactive with glass may be introduced into the recesses to form a chemical bond with the wall of the recess. Preferably therein at least the surface of the first glass plate is provided with a hydrophobic coating in which the smaller terminal cross-sectional openings of the recesses are disposed. For the reaction of the constituent of the liquid, when it is in the recess, it may be heated and/or irradiated, for example, to start or accelerate the reaction. Subsequently, optionally, the first glass plate may be rinsed and/or dried to remove any remaining portion of the liquid. As a reactive constituent, the liquid may contain, for example, a silane compound containing in addition to the silane group a reactive group, for example, a thiol group, an amino group, a carboxy group, a hydroxyl group, an epoxy group, an acid group, a carbonyl group, an alkene group, or an alkyne group, wherein the alkene or alkyne is, for example, a C2- to C12-alkene or alkyne, respectively. Such a reactive constituent through the silane group generates a reactive group bound to the glass, which reactive group can be used for binding other molecules.

Optionally, the liquid containing the reactive constituent is introduced into a recess as a volume that is at maximum equal to the volume or smaller than the volume of the recess between its terminal cross-sectional openings. A volume of the liquid smaller than the volume of the recess causes the liquid to arrange itself in the region of the smallest cross-section of the recess and, correspondingly, the reactive constituent binds there to the inner wall, optionally to a part of the surface of the first glass plate adjacent to the smallest cross-section. In this case, the volume of the liquid can be, for example, 20 to 80% or 30 to 60% of the volume of the recess.

The method may be a synthesis method or an analytical method, wherein reactive components are introduced into the recesses one after the other in separate liquid droplets. Optionally, after each introduction of a liquid droplet containing a reactive component, a droplet is introduced into the recesses as a rinsing liquid, which, for example, does not contain a reactive component. Alternatively or additionally, excitation radiation for a reactive component is irradiated onto the recesses. Different reactive components can be introduced into the recesses one after the other, each in separate droplets. Reactive components can be, for example, components for synthesis, e.g. reactive monomers of nucleic acids, e.g. nucleoside compounds, or monomers of peptides, e.g. reactive amino acid compounds. For analytical methods, reactive components can be those that sequentially bind an analyte, e.g. binding molecules, in particular antibodies, the same or different, with or without an associated indicator, from which emitted or absorbed radiation is detectable, e.g. upon irradiation with excitation radiation.

The method may comprise culturing cells in liquid droplets each disposed in a respective recess of the first glass plate, optionally comprising the step of introducing liquid droplets and/or optionally comprising the step of removing liquid from the recess. Therein, introduced and/or removed liquid may comprise medium for cell culture. For introducing cells into recesses, a medium containing cells may be introduced into recesses, e.g., by means of a feed line.

Generally, a feed line may comprise a detection device for cells and be set up to dose medium containing a predetermined number of cells into one recess each. A detection device for cells can, for example, be formed by a flow cytometer.

A conduit that is movable and positionable adjacent to recesses and that can be pressurized with negative pressure in a controlled manner can be provided for removing droplets of liquid from a recess. Therein, such a conduit is movable to and positionable on a surface of the first glass plate, e.g. movable to and positionable on the surface of the first glass plate in which liquid has been introduced or dosed, onto the cross-sectional openings of the recesses, or against the surface of the first glass plate opposite thereto.

Alternatively, a first glass plate may have channels formed in one or both of its surfaces, each discharging into at least one recess. Such channels may have a cross-section open to the surface of the glass plate, the cross-section, in particular its opposing side walls, being adapted to draw in liquid by capillary action. Such a cross-section has, for example, side walls at a distance of 100 μm to 1000 μm, e.g. 200 to 500 μm.

Embodiments of the invention are now described in more detail with reference to the figures, which schematically show in

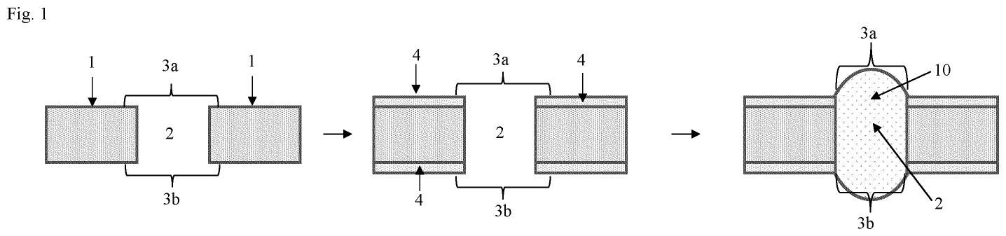

FIG. 1 the production of a carrier according to the invention from a first glass plate with a recess created therein,

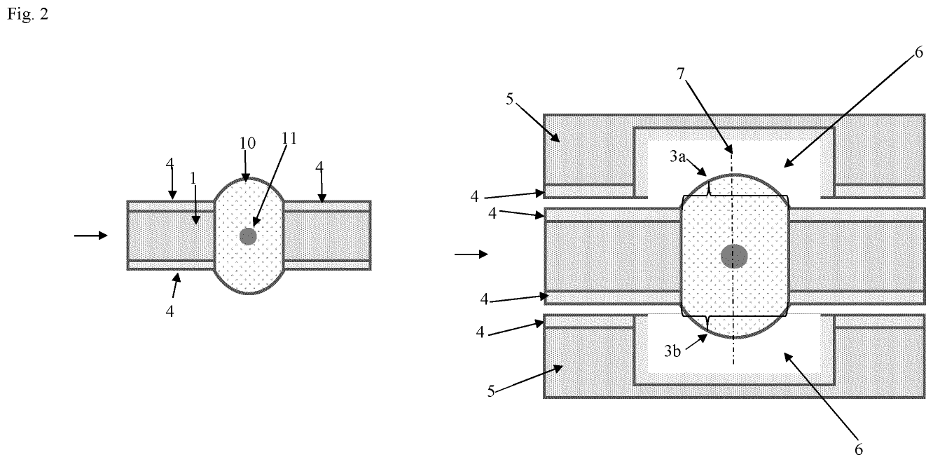

FIG. 2 another embodiment of the carrier,

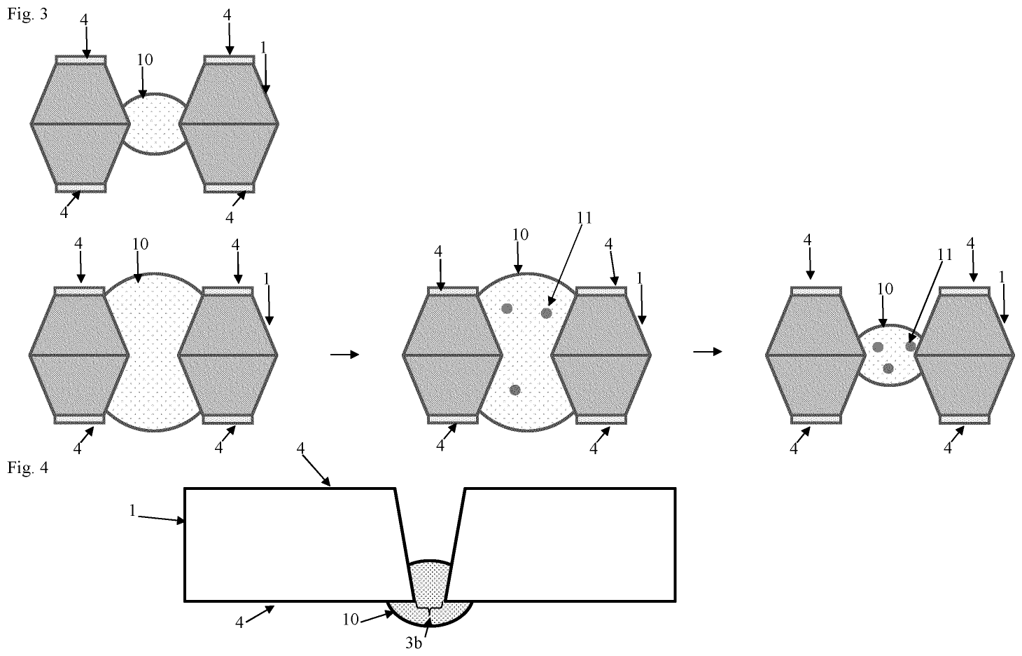

FIG. 3 a still further embodiment of the carrier,

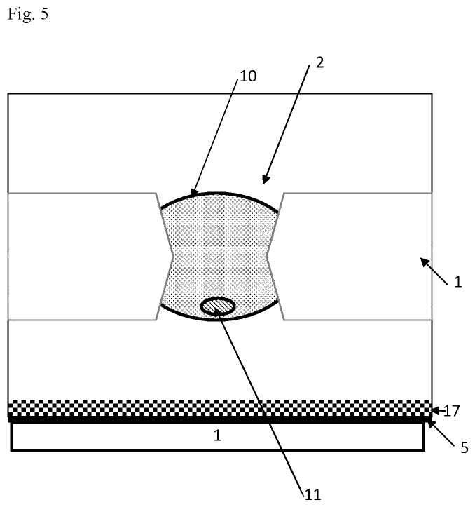

FIG. 4 a still further embodiment of the carrier,

FIG. 5 an embodiment of a method for cultivating cells in recesses of a carrier,

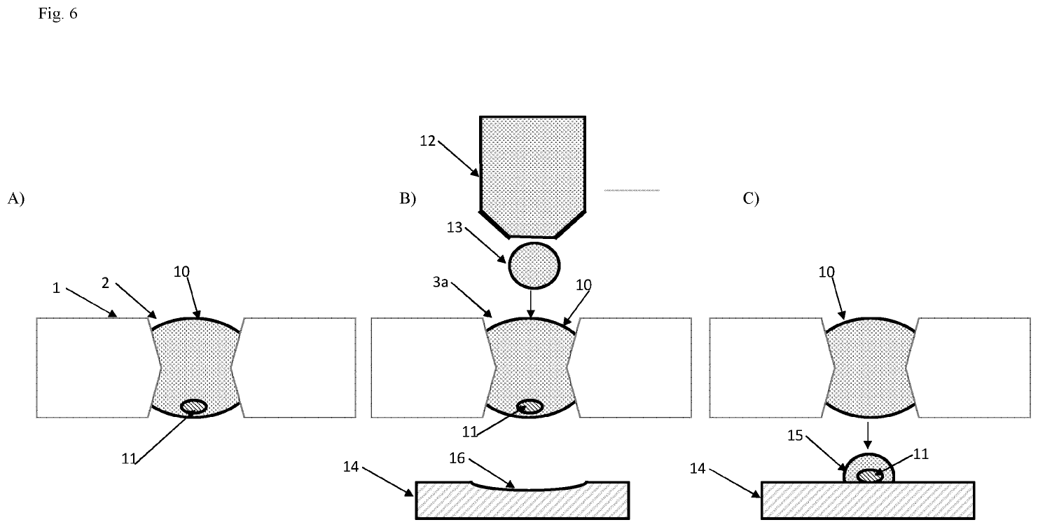

FIG. 6A) to C) a method for the targeted introduction of liquid droplets,

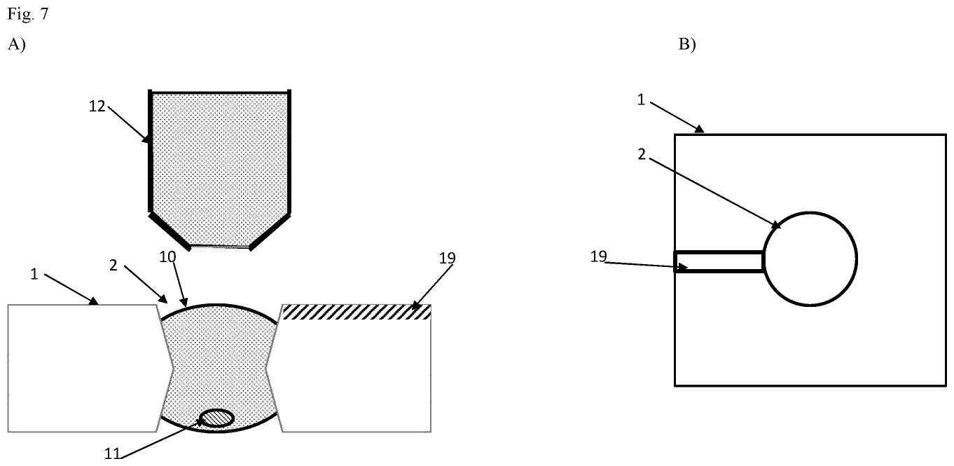

FIG. 7A), B) an embodiment of the carrier and the method for introducing and removing liquid in recesses, and

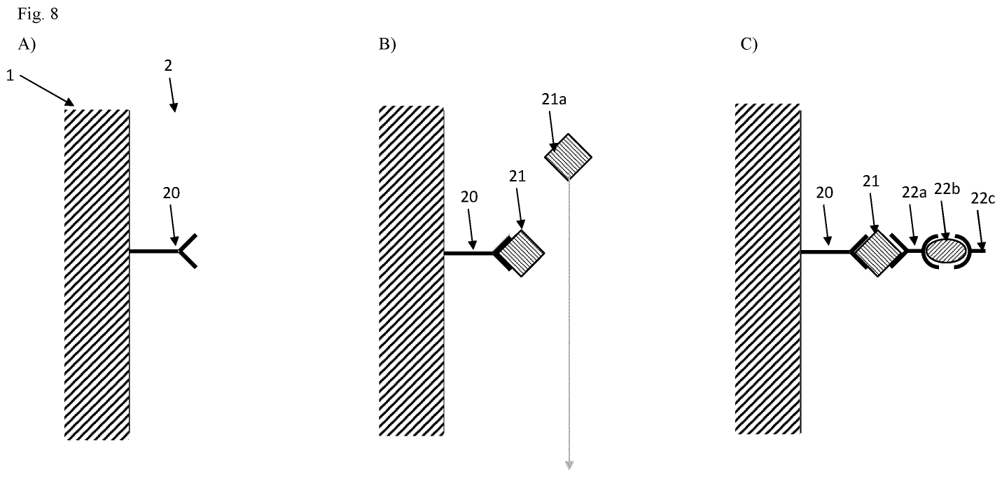

FIG. 8A) to C) a process for introducing reactive components in individual, successive steps into a recess.

In FIG. 1, a first glass plate 1 is shown in section parallel to recesses 2 formed therein. The recesses 2 are generated after laser irradiation onto the glass plate 1 by etching along the path of the laser irradiation through the glass plate 1 and completely traverse the thickness of the glass plate 1. The terminal cross-sections 3a, 3b are open in the plane of the opposing surfaces of the first glass plate 1. According to the preferred embodiment, at least one surface of the glass plate 1, in this case both opposing surfaces of the glass plate 1, are provided with a hydrophobic coating 4, e.g. by depositing fluoroalkylsilane or methylsilane or ethylsilane exclusively on the surface of the glass plate by means of, for example, microcontact printing, pad printing, screen printing or inkjet printing.

A liquid droplet 10 placed adjacent to a terminal cross-section 3a or into the recess 2 moves into the recess 2 and may protrude above its terminal cross-sections 3a, 3b if the volume of the recess 2 between its terminal cross-sections 3a, 3b is smaller.

As an example, FIG. 2 shows a liquid droplet 10 containing a biological cell 11 in a recess 2. In the embodiment shown, a second plate 5, which is preferably a glass plate, is arranged on each surface of the first glass plate 1 and has second recesses 6 arranged to match the recesses 2 of the first glass plate 1. When two second glass plates 5, each having second recesses 6, are arranged with their second recesses 6 over the terminal open cross-sections 3a, 3b of the first glass plate 1, the recesses 2 and the liquid droplets 10 held therein are isolated from the environment. The second recesses 6 of the second glass plates 5 are spaced at a radial distance from the longitudinal center axis 7 of the recess 2 and at an axial distance along the longitudinal central axis 7 from the terminal open cross-sections 3a, 3b, so that the liquid droplet 10 is covered by the second glass plates 5 without contact. According to one embodiment, FIG. 2 shows that facing the first glass plate 1 the surfaces of the second glass plates 5 may have a hydrophobic coating.

FIG. 3 shows an embodiment in which the recesses 2 in the first glass plate 1 taper from their terminal cross sections, which lie in the plane of the surfaces of the glass plate 1, to smaller inner diameters, which lie at a distance from the surfaces. From the schematic depiction, it is clear that an introduced liquid droplet by capillary forces moves to the region of the recesses 2 with the smallest inner diameter. A liquid droplet 10 filling the volume of the recess 2 can be reduced in volume by evaporation of water by exposure of the first glass plate to an atmosphere having a changed moisture content, changed temperature and/or a changed composition. It has been shown that this causes the concentrated liquid droplet 10, including biological cells 11 contained therein, to move into the area of the recess 2 with the smallest internal diameter.

FIG. 4 shows, in a partial view, a simple embodiment of the carrier of a first glass plate 1 in which a tapered conical recess 2 passing completely through the thickness of the first glass plate 1 is created as a representative example. Optionally, the glass plate 1 which has been irradiated through by a laser pulse at the locations where a recess 2 is to be created, the surface of the first glass plate 1 in which the smaller terminal cross-section 3b of the recess 2 is to be arranged, may be coated with etch resist prior to etching. It shows that a liquid droplet 10 brought to or into the recess 2 is also arranged in the region of the smaller terminal cross-sectional opening in the embodiment of the conical through-hole recesses 2. Also in this embodiment, one or both of the opposing surfaces of the first glass plate 1 may have a hydrophobic coating 4.

FIG. 5 shows a first glass plate 1 with a through-hole recess 2 in which a liquid is arranged, e.g. medium for cell culture with a cell 11 therein. At a spacing from the first glass plate 1, a second plate 5, which is for example of glass or plastic, is arranged, wherein a further liquid 17, for example medium or water, is arranged with the spacing, respectively on the second plate 5. The second plate 5 and thus the further liquid 17 are preferably temperature-controlled, in particular to a temperature at which the gas between the first glass plate 1 and the second plate 5 is saturated with water vapor. For temperature control of the second plate 5, a controlled heater 18 may be arranged at it.

FIG. 6 in A) shows a recess 2 extending through a first glass plate 1, with a liquid droplet 10 introduced therein by targeted dripping, which may contain, for example, a cell 11. The droplet 10 is held within the recess 2 by capillary forces. For introducing a liquid, e.g. medium for cell culture, a feed line in the form of a nozzle or pipette 12 is arranged at a distance from the terminal cross-section 3a of the recess 2 and ejects, e.g. by means of overpressure, a droplet 13 in the direction of the cross-section 3a. At a spacing from the first glass plate 1, a support 14 is arranged to receive liquid 15 discharged from the recess 2. The support 14 may have, for example, wells, preferably one well 16 each suitably registered with a recess 2, as shown in B), or the support may have a flat surface, as shown in C). The support 14 may be formed by a second plate 5. Negative pressure may be applied to the space between the first glass plate 1 and the support or a second plate, and/or positive pressure may be applied to the surface of the first glass plate 1 facing the support 14, to remove liquid from the recess 2.

FIG. 7 in A) shows a first glass plate 1 in cross-section with a nozzle or feed line 12 positioned at a spacing from the recess 2 to introduce liquid 10, 13 into the recess 2. A liquid droplet 10 having a cell 11 therein is arranged in the recess 2. A channel 19, for example by etching is formed in a surface of the first glass plate 1. The channel 19 discharges into the recess 2, so that liquid can pass from the channel 19 into the recess 2. Upon arrangement of the first glass plate 1 or of the channel 19 in such a way that the channel 19 is arranged in the lower surface of the glass plate 1, a channel 19 arranged there is suitable for removing liquid from the recess 2.

FIG. 7B) shows the glass plate 1 with the channel 19, the cross-section of which extends from one surface into the glass plate 1, in plan view. The channel 19 discharges into the through-hole recess 2.

FIGS. 8A) to C) show the introduction of reactive components stepwise one after the other into a recess 2 of a first glass plate 1. In FIG. 8A), a first reactive component 20 is shown bound to the surface of the recess 2 of the first glass plate 1. Subsequently, in B), a second reactive component 21 in a liquid is introduced into the recess 2, wherein the second component 21 binds to the first component. Unbound second component 21a is removed from the recess, optionally by introducing rinsing liquid. For further reaction with components 20, 21 bound to the glass support 1 in recess 2, in C), further reactive components 22a, 22b, 22c can be successively introduced into the recess each in separate liquid droplets.

The reactive components 20, 21, 22a, 22b, 22c may be monomers reactive with each other to form an oligomer, e.g., each amino acids to form peptides or reactive nucleotides, e.g., nucleotide triphosphates to form oligonucleotides.

Alternatively, the reactive components 20, 21, 22a, 22b, 22c can be components of a detection reaction, e.g. a first antibody as first reactive component 20, an analyte as second reactive component 21, for which the first antibody is specific, and at least one second antibody as a further reactive component 21a, which is also specific for the second reactive component 21, wherein the second antibody as further reactive component 22a is linked to an optically detectable label molecule, e.g. a dye, as further component 22b, optionally to an additional binding molecule as a still further component 22c

### REFERENCE SIGNS

1 first glass plate
2 through-hole recess
3a, 3b terminal cross-section
4 hydrophobic coating
5 second plate
6 second recess
7 longitudinal center line
8 liquid droplets
11 cell
12 nozzle/pipette/feed line
13 droplet
14 support
15 drained liquid
16 well
17 liquid
18 heating
19 channel
20 first reactive component
21 second reactive component
21a unbound second reactive component
22a, 22b, 22c further reactive component

1. A method of treating liquid droplets comprising; of introducing droplets of at least one liquid into recesses of a first glass plate extending through the full thickness of the first glass plate and having an inner diameter of 5 to 1000 μm and the recesses tapering in a V-shape or the inner diameter tapering from the terminal cross-sections, which lie in the plane of the opposing surfaces of the first glass plate, to a smaller inner diameter which lies at a spacing from the planes of the surfaces of the first glass plate.

2. The method according to claim 1, wherein the liquid contains a component reactive with glass, the method comprising subsequent rinsing or drying of the first glass plate to remove remaining portions of the liquid.

3. The method according to claim 2, wherein after the rinsing or after drying, droplets of at least one further liquid are introduced into the recesses.

4. The method according to claim 1, wherein at least one of the liquids introduced into the recesses contains, as a reactive component, a binding molecule which is bound in the recesses, and subsequently a further liquid is introduced into the recesses which contains an analyte which has an affinity for the reactive component and is bound by the reactive component.

5. The method according to claim 1, wherein at least one of the liquids introduced into the recesses contains at least one biological cell.

6. The method according to claim 1, wherein the opposing surfaces of the first glass plate have an applied hydrophobic coating.

7. The method according to claim 2, wherein the glass reactive ingredient is a silane compound containing a reactive group in addition to the silane group.

8. The method according to claim 2, wherein the rinsing is performed by applying liquid over the entire surface of one of the surfaces of the first glass plate and subjecting the first glass plate to a pressure gradient.

9. The method according to claim 1, wherein the introduction of drops of liquid is carried out by targeted deposition of individual droplets on terminal cross-sections of the recesses.

10. The method according to claim 9, wherein the targeted deposition of individual droplets is performed by ejecting individual droplets from a feed line which is moved at a spacing from the first glass plate and is positioned over a respective terminal cross section of a recess.

11. The method according to claim 1, wherein the introduction of droplets of a liquid into recesses is performed by ejecting drop-shaped liquid by means of overpressure from a feed line positioned at a spacing from the first glass plate.

12. The method according to claim 1, wherein the introduction of droplets of a liquid into the recesses is performed by channels etched into a surface of the first glass plate, which channels extend exclusively from the plane of the surface of the first glass plate into a thickness section adjacent thereto of preferably 10 to 50% of the thickness of the glass plate and which discharge into at least one of the recesses each.

13. The method according to claim 1, wherein a volume fraction of droplets is removed from recesses by means of channels etched into a surface of the first glass plate, which channels extend exclusively from the plane of the surface of the first glass plate into a thickness section adjacent thereto of preferably 10 to 50% of the thickness of the glass plate and which each start from at least one of the recesses.

14. The method according to claim 1, comprising arranging at least one second glass plate at a surface of the first glass plate subsequent to the introduction of liquid droplets and detecting radiation emitted from liquid droplets.

15. The method according to claim 1, wherein droplets are removed from recesses by accelerating a fluid, gaseous or liquid, in a targeted manner onto at least one of the recesses by means of a feed line and, opposite the feed line, transferring the droplets onto a support arranged at a spacing from the first glass plate.

16. The method according to claim 1, wherein the liquid droplets are each introduced with a volume which is at maximum a volume which has the volume of the recesses each case and projects beyond the terminal cross sections of the recesses at maximum to an extent which is held by the surface tension of the liquid droplet.

17. (canceled)

18. The method according to claim 1, comprising irradiating the recesses with light and detecting radiation emanating from liquid droplets arranged in recesses.

19. The method according to claim 1, wherein after introduction of droplets of a liquid, the first glass plate is exposed to an atmosphere having a changed moisture content, a changed temperature and/or a changed composition in order to reduce the volume of the introduced liquid droplets by evaporation of water or to increase it by absorption of water.

20. The method according to claim 1, wherein after introduction of liquid droplets, a second plate is arranged on at least one surface of the first glass plate to cover the recesses of the first glass plate with a spacing.

21. The method according to claim 1, wherein on at least one surface of the first glass plate, a second plate is arranged which covers the recesses of the first glass plate with a spacing, and the second plate is temperature controlled and/or a liquid and/or a gas is introduced into the spacing between the first glass plate and the second plate.

22. The method according to claim 1, wherein prior to introducing the liquid droplets a second plate is disposed on a surface of the first glass plate, and after the liquid droplets are introduced negative pressure is applied to the spacing between the first and second glass plates.

23. The method according to claim 19, wherein the second plate has no through-holes.

24. The method according to claim 19, wherein the second plate has second recesses each of which cover individual terminal cross sections of the recesses of the first glass plate with a spacing.

25. The method according to claim 18, wherein the first glass plate is impenetrable for the excitation radiation.

26. The method according to claim 19, wherein the second plate is a glass plate, a plate made of silicon or a plate made of plastic.

27. The method according to claim 1, wherein reactive components are introduced successively into the recesses in separate liquid droplets, and optionally after each introduction of a liquid droplet containing a reactive component, a droplet is introduced into the recesses as a rinsing liquid which does not contain any of the reactive components, and/or excitation radiation for a reactive component is irradiated onto the recesses.

28. Use of a first glass plate having recesses extending through the full thickness of the first glass plate and having an inner diameter of 5 to 1000 μm and the recesses tapering in a V-shape, or the inner diameter tapering from the end cross-sections lying in the plane of the surfaces of the first glass plate facing each other to a smaller inner diameter which is at a spacing from the planes of the surfaces of the first glass plate, as a holding device for liquid droplets held in the recesses, wherein the walls of the recesses are hydrophilic and optionally at least one of the surfaces of the first glass plate is hydrophobically coated.

29. The use according to claim 28, wherein a second plate is arranged on at least one surface of the first glass plate and covers the recesses thereof with a spacing from the first glass plate.

30. The use according to one of claim 28, wherein a second plate is arranged on each of the two surfaces of the first glass plate, each having second recesses which matchingly cover the recesses of the first glass plate and at a spacing from the terminal cross sections of the recesses.

31. The use according to one of claim 28, wherein the recesses have bound reactive molecules, in particular at least one silane compound, in the area of their smallest cross section.

32. The use according to claim 28, wherein the area of the recesses of smallest cross-section lies in the plane of a surface of the first glass plate provided with a hydrophobic coating.

33. The use according to claim 28, wherein the surfaces of the first glass plate are free of components arranged thereon that are arranged between neighboring recesses and/or arranged closer than the distance between neighboring recesses.

34. The use according to claim 28, wherein channels are etched in at least one of the surfaces of the first glass plate, which channels extend exclusively from the plane of the surface of the first glass plate into a thickness section adjacent thereto of preferably 10 to 50% of the thickness of the glass plate and which each discharge into at least one of the recesses.

35. The use according to claim 34, opposite to wherein the surface of the first glass plate within which channels are etched that each discharge into at least one of the recesses, channels are etched into the surface of the first glass plate which extend exclusively from the plane of the surface of the first glass plate into a thickness portion adjacent thereto of preferably 10 to 50% of the thickness of the glass plate and which each start from at least one of the recesses.

36. The use according to claim 28, wherein a fluid, gaseous or liquid, is accelerated in a targeted manner onto at least one of the recesses by a feed line and droplets are removed from recesses opposite to the feed line and transferred onto a support arranged at a spacing from the first glass plate.

37. A process for producing a carrier having a first glass plate with recesses for receiving liquid droplets, in which the recesses are produced by spot irradiation of an original first glass plate with a laser beam and subsequent etching of the first glass plate up to an inner diameter of the recesses of 5 to 1000 μm and until the recesses extend through the entire thickness of the first glass plate, the etching being performed until the first glass plate has a thickness of 100 to 1000 μm, etching the first glass plate being performed until the inner diameter of the recesses tapers from the terminal cross sections lying in the plane of the opposing surfaces of the first glass plate to a smaller inner diameter lying at a spacing from the planes of the surfaces of the first glass plate, and after the etching, optionally at least one surface of the first glass plate is coated with a hydrophobic coating.

38. The method of claim 37, characterized in that wherein one of the surfaces of the first glass plate is coated with etch resist prior to etching, and after etching, the etch resist is removed to form V-shaped recesses.

39. The method according to claim 37, wherein after etching, a volume of a liquid containing a glass-reactive constituent is introduced into the recesses, said volume being at maximum equal to or smaller than the volume of the recesses between their terminal cross-sectional openings.
